(19) United States
(12) Patent Application Publication
(10) Pub. No.: US 2024/0332686 A1
(43) Pub. Date: Oct. 3, 2024

(54) TAB AND BATTERY COMPRISING TAB

(71) Applicant: ZHUHAI COSMX BATTERY CO., LTD., Zhuhai (CN)

(72) Inventors: Wenrong LIN, Zhuhai (CN); Suli LI, Zhuhai (CN); Fei HE, Zhuhai (CN); Jiajia PEI, Zhuhai (CN); Junyi LI, Zhuhai (CN)

(21) Appl. No.: 18/737,566

(22) Filed: Jun. 7, 2024

Related U.S. Application Data
(63) Continuation of application No. PCT/CN2022/138099, filed on Dec. 9, 2022.

(30) Foreign Application Priority Data
Jan. 10, 2022 (CN) 202210023542.5

(51) Int. Cl. H01M 50/184; H01M 50/105; H01M 50/121; H01M 50/186; H01M 50/193; H01M 50/536

(52) U.S. Cl. CPC H01M 50/184; H01M 50/105; H01M 50/121; H01M 50/186; H01M 50/193; H01M 50/536

(57) ABSTRACT

The present application provides a tab and a battery including the tab. The tab includes a metal conductor and an insulation sealing gasket, where the insulation sealing gasket includes a heat-sealing outer layer, an outer transition layer, a core layer, an inner transition layer and a low-softening-point inner layer connected in sequence. The tab of the present application is able to fully guarantee the bonding sealing performance and electrolyte resistance performance of the tab, ensuring the safety performance of the battery. At the same time, it is also able to effectively reduce the heat-sealing temperature and heat-sealing time, shorten the time of packaging, greatly reduce the production energy consumption, and improve the production efficiency. Moreover, it is also able to meet the safe use of the battery under high voltage, large current or direct high temperature conditions.

### CROSS-REFERENCE TO RELATED APPLICATIONS

This application is a continuation of International Application No. PCT/CN2022/138099, filed on Dec. 9, 2022, which claims priority to Chinese Patent Application No. 202210023542.5, entitled “TAB AND BATTERY COMPRISING TAB”, and filed with the China National Intellectual Property Administration on Jan. 10, 2022. The disclosures of the aforementioned applications are hereby incorporated by reference in their entireties.

### TECHNICAL FIELD

The present application belongs to the technical field of batteries, and in particular relates to a tab and a battery including the tab.

### BACKGROUND

Due to the advantages of high energy density and long battery life, soft pack battery is widely used in various fields, such as mobile phones, laptops, electric vehicles, electric ships, etc. The production process of soft pack battery involves a packaging process, that is, the aluminum-plastic packaging film and the insulation gasket of the tab need to be top-sealed to achieve melt sealing.

At present, the tab for the soft pack battery generally uses a tab adhesive of an single-layer, two-layer or three-layer insulation sealing gasket having a softening point of 130° C. to 170° C. as a sealing material, which results in that the battery packaging production requires high temperature, high pressure, and long packaging time, not only increasing the production energy consumption and reducing production efficiency, but also the tab adhesive of such structure being easy to be deformed during high-temperature sealing process, which leads to a risk of electrochemical corrosion of battery.

In addition, when the soft pack battery is used for charging and discharging under conditions of large current, high voltage and high temperature, the battery generally generates a large amount of heat, resulting in high temperature of battery, high degree of decomposition and vaporization of the internal electrolyte, severe thermal shrinkage of separator, aggravated side reaction of positive and negative electrodes, which results in severe swelling and deformation of battery. Since current conventional soft pack batteries still use current conventional tab adhesives as insulation sealing gasket, during high temperature charging and discharging of the above-mentioned high-current and high-voltage battery, the high-pressure and high-heat combustible gas inside the severely swollen battery cannot be discharged in time, and trapped in the inner cavity of battery, and with the continued deterioration of the conditions, the battery may cause accidents such as firing, smoking and even explosion.

### SUMMARY

In order to alleviate the shortcomings of the prior art, an object of the present application is to provide a tab and a battery including the tab. The tab includes a metal conductor and an insulation sealing gasket, where the insulation sealing gasket includes a heat-sealing outer layer, an outer transition layer, a core layer, an inner transition layer and a low-softening-point inner layer, which are sequentially connected. The insulation sealing gasket of the present application is able to fully guarantee the bonding sealing performance and electrolyte resistance of the tab, ensuring the safety of the battery; meanwhile, it is also able to effectively reduce the heat-sealing temperature and heat-sealing time, shorten the packaging time, greatly reduce the production energy consumption, improve the production efficiency, and at the same time, it is also able to meet the safe use of the battery under conditions of high voltage, large current or direct high temperature.

The object of the present application is achieved through the following technical solutions.

A tab, including a metal conductor and an insulation sealing gasket, where a first end of the metal conductor is a tab welding end, and a second end of the metal conductor opposite to the first end is a tab protruding end, a tab insulation zone is formed between the tab welding end and the tab protruding end, the insulation sealing gasket is arranged on the tab insulation zone, and the insulation sealing gasket surrounds the metal conductor for a circle;

the insulation sealing gasket includes a heat-sealing outer layer, an outer transition layer, a core layer, an inner transition layer and a low-softening-point inner layer, which are connected in sequence, and the low-softening-point inner layer is arranged on a surface of the metal conductor.

According to an embodiment of the present application, the tab welding end and the tab protruding end may be an integrated metal conductor, or may be two metal conductors of the same or different materials connected by a fastening method. The fastening method may be one or more of ultrasonic welding, laser welding, arc welding or riveting.

According to an embodiment of the present application, a material of the tab protruding end may be, for example, aluminum, nickel, copper, aluminum-nickel alloy, aluminum-silver alloy, nickel-silver alloy, zinc-copper alloy, copper-silver alloy, nickel-plated copper or nickel-plated aluminum.

According to an embodiment of the present application, a material of the tab welding end may be, for example, aluminum, nickel, copper, aluminum-nickel alloy, aluminum-silver alloy, nickel-silver alloy, zinc-copper alloy, copper-silver alloy, nickel-plated copper or nickel-plated aluminum.

According to an embodiment of the present application, the tab protruding end is configured to communicate with the outside and conduct electricity.

According to an embodiment of the present application, the tab welding end is welded on a current collector.

According to an embodiment of the present application, a thickness of the insulation sealing gasket is 41 μm to 300 μm, for example, 55 μm to 200 μm, exemplarily 41 μm, 42 μm, 45 μm, 50 μm, 55 μm, 60 μm, 65 μm, 70 μm, 80 μm, 90 μm, 100 μm, 110 μm, 120 μm, 130 μm, 140 μm, 150 μm, 160 μm, 170 μm, 180 μm, 190 μm, 200 μm, 220 μm, 250 μm, 280 μm or 300 μm.

According to an embodiment of the present application, the heat-sealing outer layer is a layer that is in direct contact with the aluminum-plastic film during top sealing process of the battery, and is arranged at a farthest end of the metal conductor.

According to an embodiment of the present application, a thickness D1 of the heat-sealing outer layer satisfies 10 μm≤D1≤150 μm. For example, the thickness D1 of the heat-sealing outer layer is 10 μm, 15 μm, 20 μm, 25 μm, 30 μm, 35 μm, 40 μm, 45 μm, 50 μm, 55 μm, 60 μm, 65 μm, 70 μm, 80 μm, 90 μm, 100 μm, 110 μm, 120 μm, 130 μm, 140 μm or 150 μm.

According to an embodiment of the present application, a thickness D2 of the outer transition layer satisfies 10 μm≤D2≤100 μm. For example, the thickness D2 of the outer transition layer is 10 μm, 15 μm, 20 μm, 25 μm, 30 μm, 35 μm, 40 μm, 45 μm, 50 μm, 55 μm, 60 μm, 65 μm, 70 μm, 80 μm, 90 μm or 100 μm.

According to an embodiment of the present application, a thickness D3 of the core layer satisfies 1 μm≤D3≤50 μm. For example, the thickness D3 of the core layer is 1 μm, 2 μm, 4 μm, 5 μm, 8 μm, 10 μm, 15 μm, 20 μm, 25 μm, 30 μm, 35 μm, 40 μm, 45 μm or 50 μm. Exemplarily, the thickness D3 of the core layer satisfies Min (D2, D4)/10≤D3≤Min (D2, D4)/2, where the Min (D2, D4) refers to a smaller thickness of the thickness D2 of the outer transition layer and a thickness D4 of the inner transition layer.

According to an embodiment of the present application, the thickness D4 of the inner transition layer satisfies 10 μm≤D4≤100 μm. For example, the thickness D4 of the inner transition layer is 10 μm, 15 μm, 20 μm, 25 μm, 30 μm, 35 μm, 40 μm, 45 μm, 50 μm, 55 μm, 60 μm, 65 μm, 70 μm, 80 μm, 90 μm or 100 μm.

According to an embodiment of the present application, a thickness D5 of the low-softening-point inner layer satisfies 10 μm≤D5≤200 μm. For example, the thickness D5 of the low-softening-point inner layer is 10 μm, 15 μm, 20 μm, 25 μm, 30 μm, 35 μm, 40 μm, 45 μm, 50 μm, 55 μm, 60 μm, 65 μm, 70 μm, 80 μm, 90 μm, 100 μm, 110 μm, 120 μm, 130 μm, 140 μm, 150 μm, 160 μm, 170 μm, 180 μm, 190 μm or 200 μm.

According to an embodiment of the present application, the insulation sealing gasket includes a five-layer structure, that is, the heat-sealing outer layer, the outer transition layer, the core layer, the inner transition layer and the low-softening-point inner layer connected in sequence.

According to an embodiment of the present application, the heat-sealing outer layer is a polymer layer, for example, a polymer layer with a low softening point, which is able to well reduce the temperature and time required for hot-melting for top sealing with an aluminum-plastic film top seal in the battery packaging process (i.e., top sealing process with the aluminum-plastic film), improving the production efficiency and reducing the production energy consumption.

According to an embodiment of the present application, the outer transition layer is a polymer layer compatible with both the heat-sealing outer layer and the core layer, which is able to improve a bonding force between the heat-sealing outer layer and the core layer.

According to an embodiment of the present application, the core layer is a polymer layer, for example, a polymer layer with a high softening point. During the battery packaging process, this layer serves as a high-temperature skeleton layer, which may maintain good stiffness and appearance, prevent thermal deformation of the insulation sealing gasket, and reduce the side voltage of the battery, thereby avoiding a risk of short circuit of a tab lead or a risk of electrochemical corrosion.

According to an embodiment of the present application, the inner transition layer is a polymer layer compatible with both the low-softening-point inner layer and the core layer, which may improve a bonding force between the low-softening-point inner layer and the core layer.

According to an embodiment of the present application, the low-softening-point inner layer is a polymer layer, for example, a polymer layer with a low softening point and good fluidity, which may realize separation of the insulation sealing gasket from the metal conductor during charge and discharge process of the battery under high temperature, high voltage or large current, and complete opening of the top seal, which facilitates the discharge of the internal high-temperature and high-pressure combustible gas and prevents the battery from catching fire, smoking, explosion, etc., greatly improving the use safety of the battery and a passing rate of the battery in some routine tests.

According to an embodiment of the present application, the polymer of the heat-sealing outer layer, for example, is selected from polyolefin with a low softening point, modified polyolefin with a low softening point, or blend of polyolefin and modified polyolefin with a low softening point.

Where, the polyolefin in the polyolefin with a low softening point is selected from at least one of polyethylene, polypropylene, polybutene, polypentene, polyvinyl chloride and in the like.

Where, the modified polyolefin is selected from at least one of copolymerization-modified polyolefin, graft-modified polyolefin, crosslinking-modified polyolefin and the like.

The graft-modified polyolefin is selected from at least one of maleic anhydride graft-modified polyolefin, acrylic acid graft-modified polyolefin, methacrylic acid graft-modified polyolefin, isocyanate graft-modified polyolefin, azoline graft-modified polyolefin, acrylamide graft-modified polyolefin and the like.

The copolymerization-modified polyolefin is selected from at least one of styrene-olefin copolymer, ethylene-propylene copolymer, ethylene-butene copolymer, propylene-butene copolymer, ethylene-pentene copolymer, polyethylene glycol dimethyl ether-olefin copolymer, vinyl chloride-olefin copolymer and the like; where the olefin is selected from at least one of propylene, ethylene, butene, pentene and the like.

The crosslinking-modified polyolefin is selected from at least one of silane crosslinking-modified polyolefin, acrylate crosslinking-modified polyolefin, peroxide diethylpropylbenzene crosslinking-modified polyolefin, benzoic acid peroxide crosslinking-modified polyolefin, peroxide dicarbonate diester crosslinking-modified polyolefin, tert-butyl perbenzoate crosslinking-modified polyolefin and the like.

According to an embodiment of the present application, the softening point of the polymer of the heat-sealing outer layer is, for example, 100° C. to 150° C. Further, the polymer of the heat-sealing outer layer has a melt index of 7-12 g/10 min and a crystallinity of 30%-65%.

According to an embodiment of the present application, a surface tension σ₁ of the heat-sealing outer layer is ≥25 mN/m, for example, the surface tension σ₁ of the heat-sealing outer layer is 25 mN/m≤σ₁≤60 mN/m, and the heat-sealing outer layer with the above surface tension is conducive to sufficient fusion with aluminum-plastic film package, and enhances the heat-sealing strength with aluminum-plastic film to improve sealing barrier performance.

According to an embodiment of the present application, the polymer of the outer transition layer is selected from, for example, at least one of propylene homopolymer, butene homopolymer, pentene homopolymer, propylene-ethylene copolymer, propylene-butene copolymer, ethylene-butene copolymer, ethylene-pentene copolymer, propylene-pentene copolymer, olefin-vinyl chloride copolymer (such as ethylene-vinyl chloride copolymer, propylene-vinyl chloride copolymer, butene-vinyl chloride copolymer, pentene-vinyl chloride copolymer), styrene-olefin copolymer (such as styrene-butadiene copolymer, styrene-propylene copolymer, styrene-ethylene copolymer), thermosetting resin (such as epoxy resin, polyester resin, vinyl ester, polyimide resin, isocyanate resin), polyvinylidene fluoride, polyurethane rubber, acrylate rubber, chloroprene rubber and the like.

According to an embodiment of the present application, the softening point of the polymer of the outer transition layer is 130° C. to 200° C. Further, the high molecular polymer of the outer transition layer has a melt index of 3-10 g/10 min and a crystallinity of 35%-75%.

According to an embodiment of the present application, the polymer of the core layer, for example, is selected from at least one of ethylene homopolymer, propylene homopolymer, propylene-butene copolymer, propylene-pentene copolymer, ethylene-butene copolymer, ethylene-pentene copolymer, ethylene-vinyl chloride copolymer, propylene-vinyl chloride copolymer, butene-vinyl chloride copolymer, pentene-vinyl chloride copolymer, polyvinyl chloride, polyamide, polyethylene terephthalate, polyimide, tetrafluoroethylene homopolymer, styrene homopolymer, acrylonitrile-butadiene-styrene graft copolymer, poly-p-phenylene terephthalamide, thermosetting resin (such as epoxy resin, polyester resin, polyvinyl ester, polyimide resin, isocyanate resin), polyvinylidene fluoride, styrene butadiene copolymer, polyurethane rubber, acrylate rubber, chloroprene rubber and the like.

According to an embodiment of the present application, the polymer of the core layer has a softening point of 170° C. to 250° C. Further, the polymer of the core layer has a melt index of 2-8 g/10 min and a crystallinity of 40%-75%.

According to an embodiment of the present application, the polymer of the inner transition layer, for example, is selected from at least one of propylene-ethylene copolymer, propylene homopolymer, butene homopolymer, pentene homopolymer, propylene-butene copolymer, ethylene-butene copolymer, ethylene-pentene copolymer, propylene-pentene copolymer, olefin-vinyl chloride copolymer (such as ethylene-vinyl chloride copolymer, propylene-vinyl chloride copolymer, butene-vinyl chloride copolymer, pentene-vinyl chloride copolymer), styrene-olefin copolymer (such as styrene-butadiene copolymer, styrene-propylene copolymer, styrene-ethylene copolymer), thermosetting resin (such as epoxy resin, polyester resin, vinyl ester, polyimide resin, isocyanate resin), polyvinylidene fluoride, polyurethane rubber, acrylate rubber, polyvinyl chloride, chloroprene rubber and the like.

According to an embodiment of the present application, the softening point of the polymer of the inner transition layer is 130° C. to 200° C. Further, the polymer of the inner transition layer has a melt index of 3-10 g/10 min and a crystallinity of 35%-75%.

According to an embodiment of the present application, the polymer of the low-softening-point inner layer, for example, is selected from at least one of polyethylene, polypropylene, polyvinyl chloride, maleic anhydride graft-modified polyethylene, maleic anhydride graft-modified polypropylene, acrylic acid graft-modified polyethylene, acrylic acid graft-modified polypropylene, methacrylic acid graft-modified polyethylene, methacrylic acid graft-modified polypropylene, isocyanate graft-modified polyethylene, isocyanate graft-modified polypropylene, azoline graft-modified polyethylene, azoline graft-modified polypropylene, acrylamide graft-modified polyethylene, acrylamide graft-modified polypropylene, ethylene-styrene copolymer, ethylene-propylene copolymer, ethylene-butene copolymer, polyethylene glycol dimethyl ether-polyethylene copolymer, polyethylene glycol dimethyl ether-polypropylene copolymer, ethylene-vinyl chloride copolymer, propylene-vinyl chloride copolymer, silane crosslinking-modified polyethylene, silane crosslinking-modified polypropylene, acrylate crosslinking-modified polyethylene, acrylate crosslinking-modified polypropylene, peroxide diethylpropylbenzene crosslinking-modified polyethylene, peroxide diethylpropylbenzene crosslinking-modified polypropylene, benzoic acid peroxide crosslinking-modified polyethylene, benzoic acid peroxide crosslinking-modified polypropylene, peroxide dicarbonate diester crosslinking-modified polyethylene, peroxide dicarbonate diester crosslinking-modified polypropylene, tert-butyl perbenzoate crosslinking-modified polyethylene, tert-butyl perbenzoate crosslinking-modified polypropylene and the like.

According to an embodiment of the present application, the softening point of the polymer of the low-softening-point inner layer is 100° C. to 150° C. Further, the polymer in the low-softening-point inner layer has a melt index of 7-12 g/10 min and a crystallinity of 30%-65%.

According to an embodiment of the present application, a surface tension σ₂ of the low-softening-point inner layer is ≥25 mN/m, for example, the surface tension σ₂ of the low-softening-point inner layer is 25 mN/m≤02360 mN/m, and the low-softening-point inner layer with the above surface tension is conducive to sufficient fusion with a mental conductor, and enhances the sealing barrier performance with the mental conductor.

The present application further provides a battery, which includes the above tab.

The beneficial effects of the present application are as follows.

The present application provides a tab and a battery including the tab, where the tab includes a metal conductor and an insulation sealing gasket, where the insulation sealing gasket includes a heat-sealing outer layer, an outer transition layer, a core layer, an inner transition layer and a low-softening-point inner layer connected in sequence. The tab of the present application is able to fully guarantee the bonding sealing performance and electrolyte resistance performance of the tab, ensuring the safety performance of the battery. At the same time, it is also able to effectively reduce the heat-sealing temperature and heat-sealing time, shorten the time of packaging, greatly reduce the production energy consumption, and improve the production efficiency. Moreover, it is also able to meet the safe use of the battery under high voltage, large current or direct high temperature condition.

### BRIEF DESCRIPTION OF DRAWINGS

In order to illustrate the technical solutions in the embodiments of the present application or in the related art more clearly, the drawings required in the description of the embodiments or of the related art will be briefly introduced below. Obviously, the drawings in the following description are only some of embodiments of the present application. For a person skilled in the art, other drawings may also be obtained based on these drawings without creative work.

FIG. 1 is a structural schematic diagram of a tab described in an embodiment of the present application.

FIG. 2 is a structural schematic diagram of the tab in FIG. 1 taken along a-a cross-section.

FIG. 3 is a structural schematic diagram of an insulation sealing gasket described in an embodiment of the present application.

### DESCRIPTION OF REFERENCE SIGNS

1—Metal conductor; 11—Metal welding end; 12—Metal protruding end; 2—insulation sealing gasket; 21Πeat-sealing outer layer; 22—Outer transition layer; 23—Core layer; 24—Inner transition layer; 25—Low-softening-point inner layer.

### DESCRIPTION OF EMBODIMENTS

In the following, the technical solutions in the examples of the present application will be clearly and completely described in combination with the drawings in the examples of the present application. Obviously, the described examples are some of the examples of the present application, but not all of them. Based on the examples in the present application, all other examples obtained by a person skilled in the art without creative work will fall within the protection scope of the present application.

The experimental methods used in the following examples are conventional methods unless otherwise specified. The reagents and materials used in the following examples are commercially available unless otherwise specified.

### Example 1

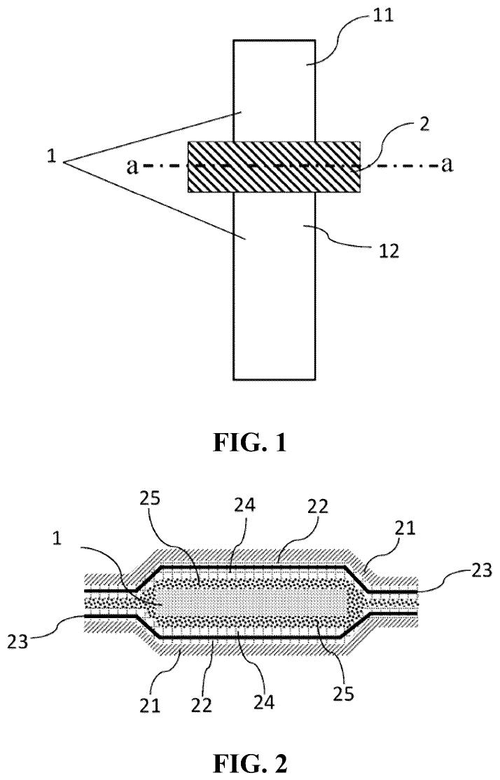

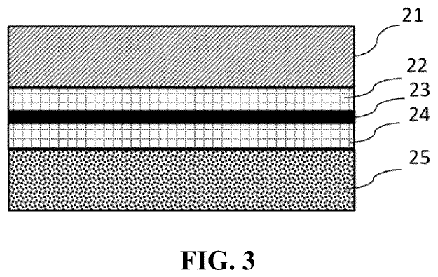

Referring to FIGS. 1 to 3, a tab is shown, and the tab includes a metal conductor 1 and an insulation sealing gasket 2, where the metal conductor 1 is an integrated aluminum tab with a thickness of 0.1 mm and a width of 8 mm, that is, the metal welding end 11 and the metal protruding end 12 are all aluminum material metal conductors; the insulation sealing gasket 2 is a five-layer structure with a total thickness of 80 μm, which are respectively a heat-sealing outer layer 21, an outer transition layer 22, a core layer 23, an inner transition layer 24 and a low-softening-point inner layer 25 that are successively connected. Where, the low-softening-point inner layer 25, which is attached to the metal conductor 1, has a thickness of 20 μm, and is a polymer layer of maleic anhydride graft-modified polyethylene, with a softening point of 125° C., a melt index of 10 g/10 min, a crystallinity of 40%, and a surface tension of 28 mN/m. The inner transition layer 24 has a thickness of 15 μm, and is a mixed polymer layer of propylene homopolymer and polyurethane rubber, with a softening point of 145° C., a melt index of 6 g/10 min, and a crystallinity of 55%. The core layer 23 has a thickness of 10 μm, and is a mixed polymer layer of propylene homopolymer, ethylene homopolymer and polyurethane rubber, with a softening point of 170° C., a melt index of 6 g/10 min, and a crystallinity of 60%. The outer transition layer 22 has a thickness of 15 μm, and is a mixed polymer layer of propylene homopolymer and polyurethane rubber, with a softening point of 145° C., a melt index of 6 g/10 min, and a crystallinity of 55%. The heat-sealing outer layer 21 has a thickness of 20 μm, and is a mixed polymer layer of propylene homopolymer and ethylene homopolymer, with a softening point of 125° C., a melt index of 10 g/10 min, a crystallinity of 40%, and a surface tension of 44 mN/m.

### Example 2

Referring to FIGS. 1 to 3, a tab is shown, and the tab includes a metal conductor 1 and an insulation sealing gasket 2, where the metal conductor 1 is an integrated nickel tab with a thickness of 0.1 mm and a width of 8 mm, that is, the metal welding end 11 and the metal protruding end 12 are both nickel material metal conductors. The insulation sealing gasket 2 is a five-layer structure with a total thickness of 80 μm, which are respectively a heat-sealing outer layer 21, an outer transition layer 22, a core layer 23, an inner transition layer 24 and a low-softening-point inner layer 25 that are successively connected. Where, the low-softening-point inner layer 25, which is attached to the metal conductor 1, has a thickness of 25 μm, is a polymer layer of acrylic acid graft-modified polyethylene, with a softening point of 105° C., a melt index of 12 g/10 min, a crystallinity of 35%, and a surface tension of 26 mN/m. The thickness of the inner transition layer 24 is 10 μm, and is a mixed polymer layer of propylene homopolymer and polyurethane rubber, with a softening point of 135° C., a melt index of 8 g/10 min, and a crystallinity of 50%. The core layer 23 has a thickness of 5 μm, and is a mixed polymer layer of propylene homopolymer, polyurethane rubber and polyethylene terephthalate, with a softening point of 175° C., a melt index of 5.0 g/10 min, and a crystallinity of 60%. The outer transition layer 22 has a thickness of 10 μm, and is a mixed polymer layer of polyurethane rubber, ethylene homopolymer and propylene homopolymer, with a softening point of 145° C., a melt index of 7 g/10 min, and a crystallinity of 55%. The heat-sealing outer layer 21 has a thickness of 30 μm, and is a polymer layer of ethylene-butylene copolymer, with a softening point of 130° C., a melt index of 10 g/10 min, a crystallinity of 40%, and a surface tension of 42 mN/m.

### Example 3

Referring to FIGS. 1 to 3, a tab is shown, and the tab includes a metal conductor 1 and an insulation sealing gasket 2, where the metal conductor 1 is an integrated nickel tab with a thickness of 0.1 mm and a width of 8 mm, that is, the metal welding end 11 and the metal protruding end 12 are both nickel material metal conductors. The insulation sealing gasket 2 is a five-layer structure with a total thickness of 150 μm, which are respectively a heat-sealing outer layer 21, an outer transition layer 22, a core layer 23, an inner transition layer 24 and a low-softening-point inner layer 25 that are successively connected. Where, the low-softening-point inner layer 25, which is attached to the metal conductor 1, has a thickness of 50 μm, and is a mixed polymer layer of acrylic acid graft-modified polypropylene and polyvinyl chloride, with a softening point of 125° C., a melt index of 12 g/10 min, a crystallinity of 40%, and a surface tension of 30 mN/m. The inner transition layer 24 has a thickness of 20 μm, and is a mixed polymer layer of polyvinyl chloride and styrene-butadiene copolymer, with a softening point of 160° C., a melt index of 7 g/10 min, and a crystallinity of 60%. The core layer 23 has a thickness of 20 μm, and is a mixed polymer layer of polyvinyl chloride, styrene-butadiene copolymer, and polyurethane rubber, with a softening point of 210° C., a melt index of 4 g/10 min, and a crystallinity of 70%. The outer transition layer 22 has a thickness of 10 μm, and is a mixed polymer layer of polyvinyl chloride, propylene homopolymer, and ethylene homopolymer, with a softening point of 160° C., a melt index of 6.5 g/10 min, and a crystallinity of 65%. The heat-sealing outer layer 21 has a thickness of 50 μm, and is a mixed polymer layer of propylene homopolymer, ethylene homopolymer and polyvinyl chloride, with a softening point of 135° C., a melt index of 9.5 g/10 min, a crystallinity of 45%, and a surface tension of 46 mN/m.

### Comparative Example 1

An aluminum material metal conductor 1 with a thickness of 0.1 mm and a width of 8 mm and a Toppan single-layer insulation sealing gasket 2 commonly used in the market are selected to be bonded together to prepare a tab according to a conventional technology.

### Comparative Example 2

A nickel material metal conductor 1 with a thickness of 0.1 mm and a width of 8 mm and a Toppan single-layer insulation sealing gasket 2 commonly used in the market are selected to be bonded together to prepare a tab according to a conventional technology.

### Comparative Example 3

The tab of Comparative Example 3 is the same as that of Example 1, with the only difference that the insulation sealing gasket 2 is a four-layer structure, which are respectively an outer transition layer 22, a core layer 23, an inner transition layer 24 and a low-softening-point inner layer 25 that are successively connected.

### Comparative Example 4

The tab of Comparative Example 4 is the same as that of Example 1, with the only difference that the insulation sealing gasket 2 is a four-layer structure, which are respectively a heat-sealing outer layer 21, a core layer 23, an inner transition layer 24 and a low-softening-point inner layer 25 that are successively connected.

### Comparative Example 5

The tab of Comparative Example 5 is the same as that of Example 1, with the only difference that the insulation sealing gasket 2 is a four-layer structure, which are respectively a heat-sealing outer layer 21, an outer transition layer 22, an inner transition layer 24 and a low-softening-point inner layer 25 that are successively connected.

### Comparative Example 6

The tab of Comparative Example 6 is the same as that of Example 1, with the only difference that the insulation sealing gasket 2 is a four-layer structure, which are respectively a heat-sealing outer layer 21, an outer transition layer 22, a core layer 23 and a low-softening-point inner layer 25 that are successively connected.

### Comparative Example 7

The tab of Comparative Example 7 is the same as that of Example 1, with the only difference that the insulation sealing gasket 2 is a four-layer structure, which are respectively a heat-sealing outer layer 21, an outer transition layer 22, a core layer 23 and an inner transition layer 24 that are successively connected.

### Test Example 1

A tab and a soft pack lithium-ion battery containing the tab. The tabs obtained in Examples 1-3 and Comparative Examples 1-7 involved were tested with reference to the following method for testing the electrolyte resistance of the tabs: 10 tab samples were taken from the Examples and Comparative Examples and put into an aluminum-plastic film bag filled with an electrolyte, ensuring that the electrolyte completely immersed the tabs. Then, the aluminum-plastic film bag was sealed and placed in a constant temperature oven at 85° C. for 48 hours storage. After the test was completed, the sample bags were taken out to wash the tabs, and then whether delamination between the insulation sealing gasket and the metal conductor occurs was confirmed, so as to confirm the bonding and sealing state of the tabs after the electrolyte resistance test. The specific test results are shown in the column of electrolyte resistance performance in Table 1.

### Test Example 2

The tab products obtained in Examples 1-3 and Comparative Examples 1-7 were heat-sealed with a sealing head, and the packaging pressure and packaging time were fixed and unified for them, and the temperature required when a heat-sealing compression rate of the insulation sealing gaskets is 50% was tested. The specific test results are shown in the column of heat-sealing temperature in Table 1.

### Test Example 3

The tab products obtained in Examples 1-3 and Comparative Examples 1-7 were heat-sealed with a sealing head, and the packaging pressure and packaging time were fixed and unified for them, and the time required when a heat-sealing compression rate of the insulation heat-sealing gaskets is 50% was tested. The specific test results are shown in the column of heat-sealing time in Table 1.

### Test Example 4

The tab products obtained in Examples 1-3 and Comparative Examples 1-7 were respectively heat-sealed with aluminum-plastic films with the same specification, ensuring being heat-sealed with a hard sealing head at a heat-sealing compression rate of 50%, and the heat-sealing strength of tabs and the aluminum plastic films after being heat-sealed was tested. The specific test results are shown in the column of heat-sealing strength in Table 1.

### Test Example 5

The tab products obtained in Examples 1 to 3 and Comparative Examples 1 to 7 were prepared into soft pack lithium-ion batteries, and the batteries each include a positive electrode piece and an active material on a surface of the positive electrode piece, a negative electrode piece and an active material on a surface of the negative electrode piece, a separator, an electrolyte, an aluminum-plastic composite film, a tab and other material. The test examples shown use the same battery model, same production line and same operating machine to prepare the batteries by, for example, welding the tabs, winding, packaging, baking, formation, sorting and capacity division. And the side voltage between the negative tab and the aluminum plastic film as aluminum layer of each group of batteries was tested by a multimeter. The specific test results are shown in the column of side voltage results in Table 1.

### Test Example 6

The tab products obtained in Examples 1 to 3 and Comparative Examples 1 to 7 were prepared into soft pack lithium-ion batteries, and the batteries each include a positive electrode piece and an active material on a surface of the positive electrode piece, a negative electrode piece and an active material on a surface of the negative electrode piece, a separator, an electrolyte, an aluminum-plastic composite film, a tab and other material. The test examples shown use the same battery model, same production line and same operating machine to prepare the batteries by, for example, welding the tab, winding, packaging, baking, formation, sorting and capacity division. And fully charged batteries with qualified quality were taken for a constant furnace temperature storage test at 130° C. for 1 hour. After the test was completed, the safety statuses of the batteries and whether an opening occurs at a position of top-sealed tabs were confirmed. The specific test results are shown in the column of furnace temperature results in Table 1.

### Test Example 7

The tab products obtained in Examples 1 to 3 and Comparative Examples 1 to 7 were prepared into soft pack lithium-ion batteries, and the batteries include a positive electrode piece and an active material on a surface of the positive electrode piece, a negative electrode piece and an active material on a surface of the negative electrode piece, a separator, an electrolyte, an aluminum-plastic composite film, a tab and other material. The test examples shown use the same battery model, same production line and same operating machine to prepare the batteries by, for example, welding the tab, winding, packaging, baking, formation, sorting and capacity division. And fully charged batteries with qualified quality were taken for a simulated short-circuit test by shorting a 55 mΩ resistor to a positive tab and a negative tab. After the test was completed, the safety statuses of the batteries and whether an opening occurs at a position of top-sealed tabs were confirmed. The specific test results are shown in the column of short-circuit results in Table 1.

TABLE 1
Test results of Examples and Comparative Examples

| | | Heat- | Heat- | Heat- | | | |
|---|---|---|---|---|---|---|---|
| | Electrolyte | sealing | sealing | sealing | Side | Furnace | |
| | resistance | temperature, | time, | strength, | voltage, | temperature | Short-circuit |
| Group | performance | ° C. | s | N/mm | V | results | results |
| Example 1 | No | 160 | 0.8 | 3.2 | 0.05 | Pass; opening | Pass, |
| | delamination | | | | | occurs at top- | opening on |
| | | | | | | sealed | the top seal |
| | | | | | | position | |
| Example 2 | No | 165 | 1.0 | 3.6 | 0.03 | Pass; opening | Pass, |
| | delamination | | | | | occurs at top- | opening on |
| | | | | | | sealed | the top seal |
| | | | | | | position | |
| Example 3 | No | 172 | 1.2 | 4.0 | 0.01 | Pass; opening | Pass, |
| | delamination | | | | | occurs at top- | opening on |
| | | | | | | sealed | the top seal |
| | | | | | | position | |
| Comparative | No | 190 | 3 | 2.5 | 0.16 | Not pass; | Failed, |
| Example 1 | delamination | | | | | battery caught | battery |
| | | | | | | fire | caught fire |
| Comparative | Delamination | 195 | 5 | 2.0 | 0.55 | Not pass; | Failed, |
| Example 2 | between | | | | | battery caught | battery |
| | insulation | | | | | fire | caught fire |
| | sealing gasket | | | | | | |
| | and metal | | | | | | |
| | conductor | | | | | | |
| Comparative | No | 215 | 8 | 2.5 | 0.08 | Pass; opening | Pass, |
| Example 3 | delamination | | | | | occurs at top- | opening on |
| | | | | | | sealed | the top seal |
| | | | | | | position | |
| Comparative | Delamination | 158 | 0.8 | 2.8 | 0.11 | Pass; opening | Pass, |
| Example 4 | between heat- | | | | | occurs at top- | opening on |
| | sealing outer | | | | | sealed | the top seal |
| | layer and core | | | | | position | |
| | layer | | | | | | |
| Comparative | No | 145 | 0.5 | 2.8 | 0.62 | Pass; opening | Pass, |
| Example 5 | delamination | | | | | occurs at top- | opening on |
| | | | | | | sealed | the top seal |
| | | | | | | position | |
| Comparative | Delamination | 160 | 0.8 | 3.0 | 0.10 | Pass; opening | Pass, |
| Example 6 | between core | | | | | occurs at top- | opening on |
| | layer and | | | | | sealed | the top seal |
| | low- | | | | | position | |
| | softening- | | | | | | |
| | point inner | | | | | | |
| | layer | | | | | | |
| Comparative | Delamination | 165 | 1.1 | 3.1 | 0.06 | Not pass; | Failed, |
| Example 7 | between | | | | | battery caught | battery |
| | insulation | | | | | fire | caught fire |
| | sealing gasket | | | | | | |
| | and metal | | | | | | |
| | conductor | | | | | | |

It can be seen from the results of Test Example 1 and Test Example 2 that the tabs of the present application are able to fully guarantee the bonding sealing performance and electrolyte resistance performance of the tabs. It can be seen from the results of Test Examples 3 and 4 that the tabs described in the present application are able to effectively reduce the heat-sealing temperature and heat-sealing time, which may greatly reduce the production energy consumption and improve the production efficiency. It can be seen from the results of Test Examples 5 and 6 that the insulation sealing gaskets of the tabs described in the present application are able to improve the safety performance of batteries.

From the test results of Example 1 and Comparative Example 3, it can be seen that the absence of heat-sealing outer layer would greatly increase the temperature of top sealing and the production time, greatly increasing the production energy consumption and reducing the production efficiency.

From the test results of Example 1, Comparative Examples 4 and 6, it can be seen that the absence of the outer transition layer and the inner transition layer results in poor corrosion resistance (delamination) in the insulation sealing gasket, and the insulation sealing gasket is not able to effectively ensure the sealing reliability of the battery.

From the test results of Example 1 and Comparative Example 5, it can be seen that the absence of the core layer leads to the poor appearance of top sealing of the battery, increased side voltage of the battery, and the risk of electrochemical corrosion of the battery.

From the test results of Example 1 and Comparative Example 7, it can be seen that the absence of the low-softening-point inner layer leads to that adhesion between the insulation sealing gasket and the metal conductor, the electrolyte resistance performance and the sealing barrier performance of the battery become worse. In addition, the battery cannot pass the furnace temperature test and short-circuit test.

Compared with the prior art, the present application has significant advantages and beneficial effects. Specifically, it can be seen from the comparison of the results of the above-mentioned technical solutions and the results of the comparative examples: the tab, the preparation method and the lithium-ion battery containing the tab in the present application, have the effect of reducing the temperature of battery production and packaging, shortening the time of packaging, and at the same time are able to meet the safe use of batteries under high voltage, large current or direct high temperature conditions.

The examples in the present description are described in a related manner, and the same and similar parts of the examples may be referred to each other. Each example focuses on the difference from other examples. The above are only examples of the present application, and are not intended to limit the protection scope of the present application. Any modifications, equivalent replacements, improvements, etc. made within the spirit and principles of the present application are included within the protection scope of the present application.

What is claimed is:

1. A tab, comprising a metal conductor and an insulation sealing gasket, wherein a first end of the metal conductor is a tab welding end, a second end of the metal conductor opposite to the first end is a tab protruding end, a tab insulation zone is formed between the tab welding end and the tab protruding end, the insulation sealing gasket is arranged on the tab insulation zone, and the insulation sealing gasket surrounds the metal conductor for a circle;
the insulation sealing gasket comprises a heat-sealing outer layer, an outer transition layer, a core layer, an inner transition layer and a low-softening-point inner layer, which are connected in sequence, and the low-softening-point inner layer is arranged on a surface of the metal conductor.

2. The tab according to claim 1, wherein a thickness of the insulation sealing gasket is 41 μm to 300 μm.

3. The tab according to claim 1, wherein a thickness of the insulation sealing gasket is 55 μm to 200 μm.

4. The tab according to claim 2, wherein the thickness of the insulation sealing gasket is 55 μm to 200 μm.

5. The tab according to claim 1, wherein a thickness D1 of the heat-sealing outer layer satisfies 10 μm≤D1≤150 μm;
and/or, a thickness D2 of the outer transition layer satisfies 10 μm≤D2≤100 μm;
and/or, a thickness D3 of the core layer satisfies 1 μm≤D3≤50 μm;
and/or, a thickness D4 of the inner transition layer satisfies 10 μm≤D4≤100 μm;
and/or, a thickness D5 of the low-softening-point inner layer satisfies 10 μm≤D5≤200 μm.

6. The tab according to claim 5, wherein Min (D2, D4)/10≤D3≤Min (D2, D4)/2, in which the Min (D2, D4) refers to a smaller thickness of the thickness D2 of the outer transition layer and the thickness D4 of the inner transition layer.

7. The tab according to claim 1, wherein the heat-sealing outer layer is a polymer layer, and a softening point of a polymer of the heat-sealing outer layer is 100° C. to 150° C.;
and/or, a melt index of the polymer of the heat-sealing outer layer is 7-12 g/10 min;
and/or, a crystallinity of the polymer of the heat-sealing outer layer is 30%-65%.

8. The tab according to claim 2, wherein the heat-sealing outer layer is a polymer layer, and a softening point of a polymer of the heat-sealing outer layer is 100° C. to 150° C.;
and/or, a melt index of the polymer of the heat-sealing outer layer is 7-12 g/10 min;
and/or, a crystallinity of the polymer of the heat-sealing outer layer is 30%-65%.

9. The tab according to claim 1, wherein a surface tension σ₁ of the heat-sealing outer layer is ≥25 mN/m;
and/or, a surface tension σ₂ of the low-softening-point inner layer is ≥25 mN/m.

10. The tab according to claim 2, wherein a surface tension σ₁ of the heat-sealing outer layer is ≥25 mN/m;
and/or, a surface tension σ₂ of the low-softening-point inner layer is ≥25 mN/m.

11. The tab according to claim 1, wherein a surface tension σ₁ of the heat-sealing outer layer satisfies: 25 mN/m≤σ₁≤60 mN/m;
and/or, a surface tension σ₂ of the low-softening-point inner layer satisfies: 25 mN/m≤σ₂≤60 mN/m.

12. The tab according to claim 2, wherein a surface tension σ₁ of the heat-sealing outer layer satisfies: 25 mN/m≤σ₁≤60 mN/m;
and/or, a surface tension σ₂ of the low-softening-point inner layer satisfies: 25 mN/m≤σ₂≤60 mN/m.

13. The tab according to claim 1, wherein the outer transition layer is a polymer layer, and a softening point of a polymer of the outer transition layer is 130° C. to 200° C.;
and/or, a melt index of the polymer of the outer transition layer is 3-10 g/10 min;
and/or, a crystallinity of the polymer of the outer transition layer is 35% to 75%.

14. The tab according to claim 2, wherein the outer transition layer is a polymer layer, and a softening point of a polymer of the outer transition layer is 130° C. to 200° C.;
and/or, a melt index of the polymer of the outer transition layer is 3-10 g/10 min;
and/or, a crystallinity of the polymer of the outer transition layer is 35% to 75%.

15. The tab according to claim 1, wherein the core layer is a polymer layer, and a softening point of a polymer of the core layer is 170° C. to 250° C.;
and/or, a melt index of the polymer of the core layer is 2-8 g/10 min;
and/or, a crystallinity of the polymer of the core layer is 40% to 75%.

16. The tab according to claim 2, wherein the core layer is a polymer layer, and a softening point of a polymer of the core layer is 170° C. to 250° C.;
and/or, a melt index of the polymer of the core layer is 2-8 g/10 min;
and/or, a crystallinity of the polymer of the core layer is 40% to 75%.

17. The tab according to claim 1, wherein the inner transition layer is a polymer layer, and a softening point of a polymer of the inner transition layer is 130° C. to 200° C.;
and/or, a melt index of the polymer of the inner transition layer is 3-10 g/10 min;
and/or, a crystallinity of the polymer of the inner transition layer is 35% to 75%.

18. The tab according to claim 2, wherein the inner transition layer is a polymer layer, and a softening point of a polymer of the inner transition layer is 130° C. to 200° C.;
and/or, a melt index of the polymer of the inner transition layer is 3-10 g/10 min;
and/or, a crystallinity of the polymer of the inner transition layer is 35% to 75%.

19. The tab according to claim 1, wherein the low-softening-point inner layer is a polymer layer, and a softening point of a polymer of the low-softening-point inner layer is 100° C.-150° C.;
and/or, a melt index of the polymer of the low-softening-point inner layer is 7-12 g/10 min;
and/or, a crystallinity of the polymer of the low-softening-point inner layer is 30% to 65%.

20. A battery, comprising the tab according to claim 1.
